(19) United States
(12) Patent Application Publication
(10) Pub. No.: US 2025/0383541 A1
(43) Pub. Date: Dec. 18, 2025

(54) OPTICAL SYSTEM AND OBSERVATION APPARATUS HAVING THE SAME

(71) Applicant: CANON KABUSHIKI KAISHA, Tokyo (JP)

(72) Inventors: Hayato KATO, Tochigi (JP); Hiroto KANO, Tochigi (JP)

(21) Appl. No.: 19/194,733

(22) Filed: Apr. 30, 2025

(30) Foreign Application Priority Data
Jun. 18, 2024 (JP) 2024-097792

(51) Int. Cl. G02B 27/00; G02B 27/01; G02B 27/09; G02B 27/28

(52) U.S. Cl. CPC G02B 27/0081; G02B 27/0172; G02B 27/0944; G02B 27/0955; G02B 27/283; G02B 27/286; G02B 2027/0178

(57) ABSTRACT

An optical system includes a first unit having first and second half-transmissive reflective surfaces, and a second unit having an aperture stop and an optical element. Light from the display surface transmits through the first half-transmissive reflective surface, is reflected by the second half-transmissive reflective surface, is reflected by the first half-transmissive reflective surface, transmits through the second half-transmissive reflective surface, and is guided to the exit pupil. Light from the exit pupil transmits through the second half-transmissive reflective surface, transmits through the first half-transmissive reflective surface, and is guided to the imaging surface via the aperture stop and the optical element. In a direction orthogonal to an optical axis of the optical system, a distance from the optical axis to a center of the imaging surface is equal to or less than a distance from the optical axis to a center of the aperture stop.

### BACKGROUND

### Technical Field

The present disclosure relates to an optical system and an observation apparatus (viewing apparatus) having the same.

### Description of Related Art

Japanese Patent Application Laid-Open No. 2023-086613 discloses an optical system that has a first optical path that guides light from a display surface to an observer's pupil, and a second optical path that guides light from the observer's pupil to an image sensor.

In the optical system disclosed in Japanese Patent Application Laid-Open No. 2023-086613, an imaging optical system that guides to an image sensor light from the observer's pupil after the light passes through a part of an observation optical system having the first optical path is disposed outside an effective light beam area of the first optical path. As a viewing angle of the observation optical system increases, the imaging angle of the observer's eye, the number of parts, and finally the size of the optical system increase.

### SUMMARY

An optical system according to one aspect of the disclosure is configured to form an enlarged image of a display surface on an exit pupil and a reduced image of the exit pupil on an imaging surface. The optical system includes a first unit having, in order in a first optical path from the display surface to the exit pupil, a first half-transmissive reflective surface and a second half-transmissive reflective surface, and a second unit having, in order in a second optical path from the exit pupil to the imaging surface, an aperture stop and an optical element. Light from the display surface transmits through the first half-transmissive reflective surface, is reflected by the second half-transmissive reflective surface, is reflected by the first half-transmissive reflective surface, transmits through the second half-transmissive reflective surface, and is guided to the exit pupil. Light from the exit pupil transmits through the second half-transmissive reflective surface, transmits through the first half-transmissive reflective surface, and is guided to the imaging surface via the aperture stop and the optical element. In a direction orthogonal to an optical axis of the optical system, a distance from the optical axis to a center of the imaging surface is equal to or less than a distance from the optical axis to a center of the aperture stop. An observation apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to a first embodiment.

FIG. 2 explains a first optical path.

FIG. 3 illustrates details of a first lens unit.

FIG. 4 illustrates details of a second optical path.

FIG. 5 is a sectional view of an optical system according to a variation.

FIG. 6 is a sectional view of an optical system according to a second embodiment.

FIG. 7 illustrates an observation apparatus including the optical system according to the first or second embodiment.

FIG. 8 illustrates a display unit of the observation apparatus.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### First Embodiment

FIG. 1 is a sectional view of an optical system 1 according to a first embodiment. The optical system 1 is mounted on an observation apparatus such as a head-mounted display (HMD). The optical system 1 includes a first lens unit (first optical system) LU1 and a second lens unit (second optical system) LU2. The first lens unit LU1 is an observation optical system that forms an enlarged image of a display surface PNL on a pupil (exit pupil) EP of an observer's (viewer's) eye EYE. The second lens unit LU2 is an imaging optical system that guides to an imaging surface IM light emitted from the cornea of the eye EYE etc. and passing through the first lens unit LU1, and forms a reduced image of the pupil EP on the imaging surface. An optical path from the display surface PNL to the pupil EP will be referred to as a first optical path RY1, and an optical path from the eye EYE to the imaging surface IM will be referred to as a second optical path RY2. A polarizing unit (circularly-polarized-light converting element) FL is disposed on the first optical path RY1.

The display surface PNL can use a display surface of a display element (spatial modulation element) such as a liquid crystal display (LCD) or light emitting diode (LED) display. For example, the LCD can control the polarization state by the orientation of the liquid crystal. In other words, the function of the polarizer FL can be achieved within the display element. At that time, the polarizer FL may not be disposed on the first optical path RY1. The imaging surface IM may be a light receiving surface of an image sensor. The image sensor is, for example, a Charge Coupled Device (CCD), a Complementary Metal Oxide Semiconductor (CMOS), and a Single Photon Avalanche Diode (SPAD), etc.

The first lens unit LU1 includes a first lens G11 and a second lens G12 arranged in this order from the pupil EP side to the display surface PNL side. In this embodiment, the lens surface included in the first lens unit LU1 has a rotationally symmetrical shape with respect to the optical axis of the first lens unit LU1. The first lens G11 has a first half-transmissive reflective surface HM1, and the second lens G12 has a second half-transmissive reflective surface HM2. The number of lenses constituting the lens unit LU1 may be increased as necessary to correct a variety of aberrations. In this embodiment, the first half-transmissive reflective surface HM1 and the second half-transmissive reflective surface HM2 are included in the refractive surfaces of the first lens G11 and the second lens G12, respectively, but this embodiment is not limited to this example. For example, the first half-transmissive reflective surface HM1 and the second half-transmissive reflective surface HM2 may be provided to both sides of the first lens G11. A cover glass or the like may be disposed to provide a half-transmissive reflective surface.

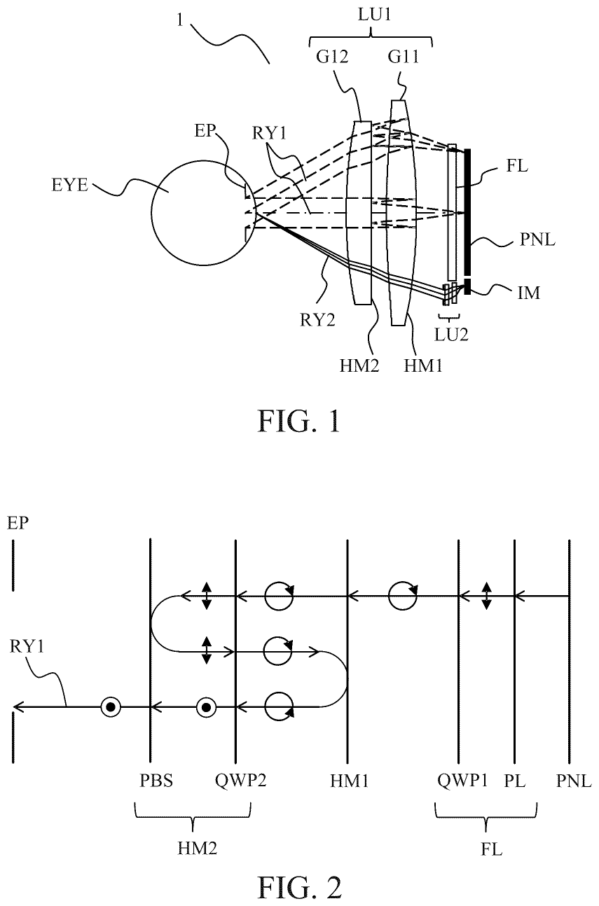

FIG. 2 illustrates the first optical path RY1. The polarizer FL includes a polarizing element (linear polarizing plate) PL and a first quarter waveplate QWP1. The light having an axis orthogonal to the transmission axis of the polarizing element PL may be absorbed by the polarizing element PL. The second half-transmissive reflective surface HM2 includes a second quarter waveplate QWP2 and a polarization-selective reflection-type polarizing element PBS.

The light beam from the display surface PNL becomes linearly polarized light by the polarizing element PL. In FIG. 2, it is formed in the vertical direction of the paper. The linearly polarized light that has transmitted through the polarizing element PL becomes circularly polarized light by the first quarter waveplate QWP1. In FIG. 2, it is formed clockwise with respect to the traveling direction. The circularly polarized light that has transmitted through the first quarter waveplate QWP1 passes through the first half-transmissive reflective surface HM1. The light beam (not illustrated) reflected by the first half-transmissive reflective surface HM1 is converted into a counterclockwise circularly polarized light with respect to the traveling direction, and is absorbed by the polarizing element PL after passing through the first quarter waveplate QWP1.

The light beam that passes through the first half-transmissive reflective surface HM1 is converted into linearly polarized light by the second quarter waveplate QWP2 and enters the polarization-selective reflective polarizing element PBS. The polarization-selective half-transmissive reflective element PBS is configured to reflect linearly polarized light polarized in the same direction as that when it passed through the polarizing element PL, and to transmit linearly polarized light orthogonal to that direction. Therefore, the light beam that transmits through the first half-transmissive reflective surface HM1 is reflected once by the polarization-selective reflective polarizing element PBS. The reflected light beam passes again through the second quarter waveplate QWP2 to become circularly polarized light, and is reflected by the first half-transmissive reflective surface HM1. The rotating direction of the circularly polarized light with respect to the traveling direction when it enters the first half-transmissive reflective surface HM1 is orthogonal to the rotating direction with respect to the traveling direction after it is reflected. Therefore, the polarization state after it passes through the second quarter waveplate QWP2 again is orthogonal to the polarization state after it passes the first time, and the light beam transmitting through the second quarter waveplate QWP2 again passes through the polarization-selective reflective polarizing element PBS and reaches the pupil EP. Therefore, in the first optical path RY1, the light beam from the display surface PNL is reflected twice. This configuration can increase the viewing angle and satisfactorily correct a variety of aberrations while suppressing the thickness of the first lens unit LU1 in the optical axis direction.

On the other hand, in the second optical path RY2, as illustrated in FIG. 1, the light beam from the pupil EP side passes through the second half-transmissive reflective surface HM2 and the first half-transmissive reflective surface HM1, and is then guided to the imaging surface IM by the second lens unit LU2. By not using an optical path that reflects light on each of the first half-transmissive reflective surface HM1 and the second half-transmissive reflective surface HM2, the number of transmissions through the half-transmissive reflective surfaces can be reduced, and a light amount incident on the imaging surface IM can be suppressed. In addition, since the light transmits through the first lens unit LU1, the imaging angle of the eye EYE can be suppressed, and light shielding at the pupil and iris caused by the eyelids and eyeball rotation can be reduced.

The first optical path RY1 is not limited to the optical path illustrated in FIG. 2, and the transmission axis of the polarizing element PL and the slow axis of the quarter waveplate may be properly changed. The polarization-selective reflective polarizing element PBS transmits or reflects linearly polarized light in this embodiment, but may be configured to transmit or reflect the light depending on the rotating direction of circularly polarized light. The half-transmissive reflective surface may also be configured to transmit or reflect light depending on the direction of linearly polarized light or circularly polarized light. In this case, the quarter waveplate is to be properly placed, but proper modifications and variations may be made within the scope of the gist of this disclosure.

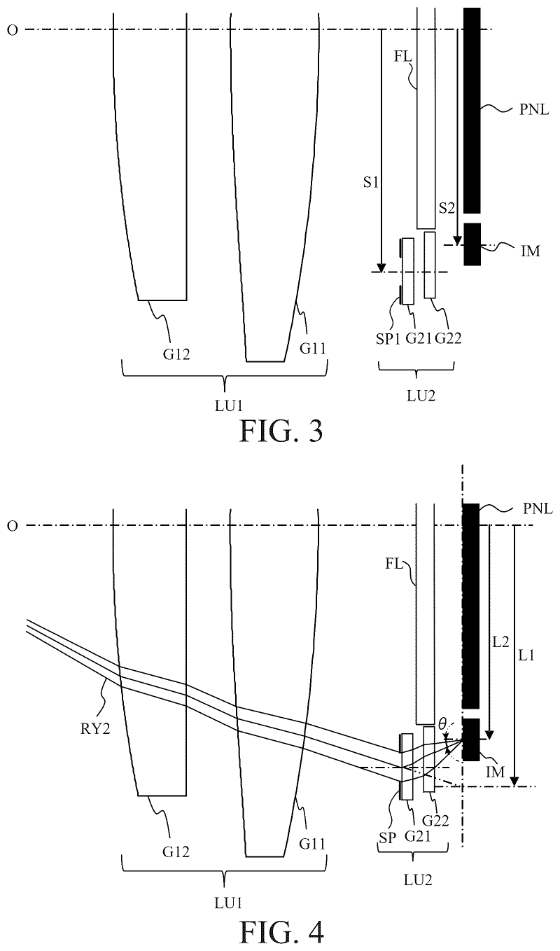

FIG. 3 illustrates the details of the first lens unit LU1. FIG. 4 illustrates the details of the second optical path RY2.

In the second optical path RY2, the light beam from the pupil EP side transmits through the peripheral parts of the second lens G12 and the first lens G11 included in the first lens unit LU1, and is guided to the imaging surface IM by the second lens unit LU2.

The second lens unit LU2 is disposed outside the effective light beam area (area where the light beam for image observation exists) of the first optical path RY1, that is, in the noneffective light beam area (area where the light beam for image observation does not exist). In this embodiment, the second lens unit LU2 includes an aperture stop SP, a third lens G21, and a fourth lens G22, arranged in this order from the pupil EP side to the display surface PNL side. The second lens unit LU2 corrects eccentric aberrations that occur when light transmits through the peripheral parts of the second lens G12 and the first lens G11, improving the detection accuracy of the imaging surface IM. In order to correct a variety of aberrations, the order of optical elements may be changed or lenses may be increased, as necessary.

The optical system 1 is configured so that a distance from the optical axis O of the first lens unit LU1 to the center of the imaging surface IM in a direction orthogonal to the optical axis O is equal to or less than a distance from the optical axis O to the aperture center of the aperture stop SP in the second lens unit LU2. This configuration can achieve an optical system 1 having a reduced size and a wide viewing angle. Integrating the image sensor that constitutes the imaging surface IM and the display element that constitutes the display surface PNL can further reduce the size of the optical system. The optical axis O is defined by the rotationally symmetrical reference axis of the optical surface of the first lens unit LU1, and is an axis that passes through the surface vertices of the lenses included in the first lens unit LU1.

A description will now be given of a configuration that may be satisfied by the optical system 1.

The optical system 1 may satisfy the following inequality (1):

$$0.6 \leq S 2 / S 1 \leq 1. \qquad ( 1 )$$

where S1 is a distance from the optical axis O to the center of the aperture stop SP of the second lens unit LU2 in the direction orthogonal to the optical axis O, and S2 is a distance from the optical axis O to the center of the imaging surface IM in the direction orthogonal to the optical axis O.

Inequality (1) enables the imaging surface IM to be brought closer to the display surface PNL even if the imaging angle of the eye EYE increases and the size of the optical system to be reduced. In a case where S2/S1 becomes higher than the upper limit, the size of the optical system 1 increases. In a case where S2/S1 becomes lower than the lower limit, it causes interference between the display surface PNL and the imaging surface IM.

Inequality (1) may be replaced with inequality (1a) below:

$$0.7 \leq S 2 / S 1 \leq 1. \qquad ( 1 a )$$

Inequality (1) may be replaced with inequality (1b) below:

$$0.7 \leq S 2 / S 1 \leq 0.98 \qquad ( 1 b )$$

In this embodiment, the distances S1 and S2 are −16.3 and −14.4, respectively, and the value S2/S1 is 0.883.

The optical system 1 may be configured so that, in a direction orthogonal to the optical axis O, a distance from the optical axis O to an intersection of an extension of a principal ray of a light beam that is emitted from a position on the optical axis O of the pupil EP and enters the second lens unit LU2 and an extension surface of the imaging surface IM is equal to or less than a distance from the optical axis O to an intersection of an extension of a principal ray of a light beam that is emitted from a position on the optical axis O of the pupil EP and emitted from the second lens unit LU2 and the extension surface of the imaging surface IM. This configuration can achieve an optical system 1 having a reduced size and a wide viewing angle.

The optical system 1 may satisfy the following inequality (2):

$$0.6 \leq L 2 / L 1 \leq 1. \qquad ( 2 )$$

Here, L1 is the distance from the optical axis O to the intersection of the extension of the principal ray of the light beam that is emitted from a position on the optical axis O of the pupil EP and enters the second lens unit LU2 and an extension surface of the imaging surface IM in the direction orthogonal to the optical axis O. L2 is the distance from the optical axis O to the intersection of the extension of the principal ray of the light beam that is emitted from the position on the optical axis O of the pupil EP and emitted from the second lens unit LU2 and the extension surface of the imaging surface IM in the direction orthogonal to the optical axis O. The principal ray is defined as a light beam that transmits through the aperture center position of the aperture stop SP in the second lens unit LU2.

Inequality (2) enables the imaging surface IM to be brought close to the display surface PNL even when the imaging angle of the eye EYE is large, and can reduce the size of the optical system. In a case where L2/L1 becomes higher than the upper limit value of inequality (2), the size of the optical system 1 increases. In a case where L2/L1 becomes lower than the lower limit of inequality (2), the display surface PNL and the imaging surface IM interfere with each other.

Inequality (2) may be replaced with inequality (2a) below:

$$0.7 \leq L 2 / L 1 \leq 1. \qquad ( 2 a )$$

Inequality (2) may be replaced with inequality (2b) below:

$$0.7 \leq L 2 / L 1 \leq 0.95 \qquad ( 2 b )$$

In this embodiment, the distances L1 and L2 are −17.6 and −16.4, respectively, and the value L2/L1 is 0.825.

The optical system 1 may satisfy the following inequality (3):

$$0 \leq θ \leq π / 3 \qquad ( 3 )$$

Here, θ is an angle [rad] between a first line parallel to the optical axis O and the extension of the principal ray of the light beam that is emitted from the position on the optical axis O of the pupil EP and emitted from the second lens unit LU2. In the direction parallel to the optical axis O, the sign of the angle θ is positive in a case where the intersection of the extension of the principal ray and the extension of the optical axis O is located on the imaging surface IM side of the second lens unit LU2, and the sign of the angle θ is negative in a case where it is located on the pupil EP side of the second lens unit LU2.

In inequality (3), in a case where θ becomes higher than the upper limit, the bending angle of the light beam in the second lens unit LU2 is to increase, and correction may be difficult, or the angle of the light beam incident on the imaging surface IM increases and the detection accuracy may lower. In a case where θ becomes lower than the lower limit, the imaging surface IM and the display surface PNL are separated, and the size of the optical apparatus increases.

Inequality (3) may be replaced with inequality (3a) below:

$$π / 12 \leq θ \leq π / 3 \qquad ( 3 a )$$

Inequality (3) may be replaced with inequality (3b) below:

$$π / 6 \leq θ \leq π / 3 \qquad ( 3 b )$$

In this embodiment, the angle θ is 0.181π [rad].

The second lens unit LU2 may include an optical surface that has asymmetry in the direction orthogonal to the optical axis O, based on the intersection of the principal ray of the second optical path RY2 and the optical surface. Thereby, the eccentric aberration that occurs when the light transmits through the peripheral parts of the second lens G12 and the first lens G11 can be more effectively corrected, and the traveling direction of the light beam can be bent in a direction approaching the display surface PNL.

In the second lens unit LU2, the third lens G21 and the fourth lens G22 may include a diffractive surface. Thereby, the traveling direction of the light beam is effectively bent in the direction approaching the display surface PNL, and the imaging surface IM and the display surface PNL can be closer to each other. The second lens unit LU2 may include two or more diffractive surfaces.

In a case where the second lens unit LU2 includes two or more diffractive surfaces, a distance from the optical axis O to the center position of the optically effective area of each diffractive surface may be different in the direction orthogonal to the optical axis O. More specifically, the plurality of optical elements are arranged with their respective optically effective areas shifted so that a distance (absolute value) from the optical axis O to a center position of an optically effective area in a diffractive surface closer to the imaging surface IM is smaller. In this embodiment, a distance from the optical axis O to the center position of the optically effective area in the diffractive surface of the fourth lens G22 is smaller than a distance from the optical axis O to the center position of the optically effective area in the diffractive surface of the third lens G21. In this embodiment, the distance from the optical axis O to the center position of the optically effective area in the diffractive surface of the third lens G21 is −16.3 mm, and the distance from the optical axis O to the center position of the optically effective area in the diffractive surface of the fourth lens G22 is −15.5 mm.

The optical elements may be arranged so that the principal ray of the light beam incident on each diffractive surface and the center of the optically effective area of each diffractive surface approximately coincide with each other. The traveling direction of the light beam may be bent in the direction approaching the display surface PNL, a variety of aberrations can be effectively corrected, and thereby the detection accuracy of the imaging surface IM can be improved.

In this embodiment, each of the third lens G21 and the fourth lens G22 has a diffractive surface, but this embodiment is not limited to this example, and for example, both sides of the third lens G21 may have diffractive surfaces. This embodiment is not limited to a diffractive surface, and may include a refractive surface or a reflective surface.

The imaging surface IM and the display surface PNL may be arranged so that their normals (normal lines) are parallel to each other, or so that the extended surface of the imaging surface IM and the extended surface of the display surface PNL are on the same plane. This configuration can integrate the image sensor constituting the imaging surface IM and the display element constituting the display surface PNL, and reduce the size of the optical system. Parallel and the same plane do not have to be strictly parallel or the same plane, and may be substantially parallel (approximately parallel) or substantially the same plane (approximately the same plane).

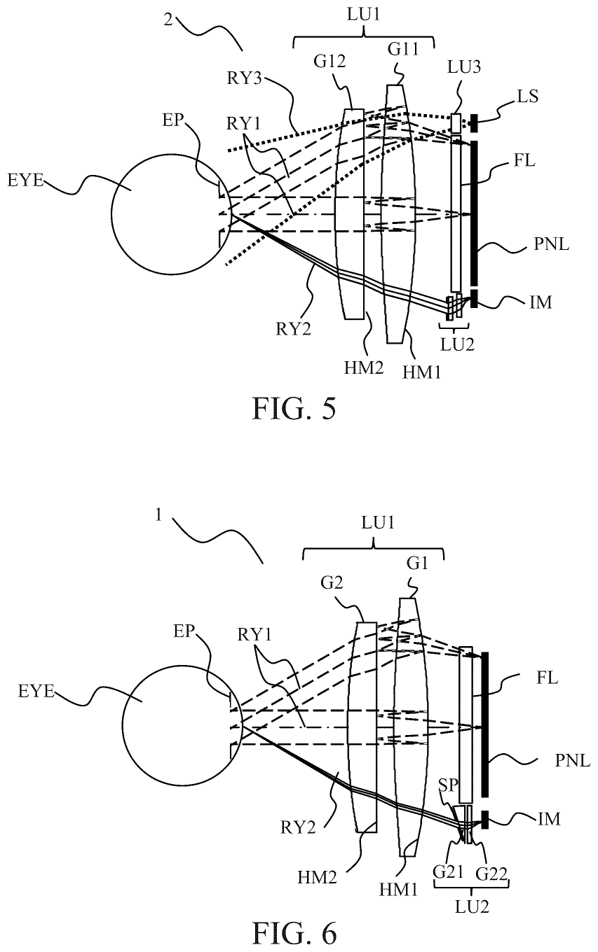

FIG. 5 is a sectional view of an optical system 2 according to a variation of the optical system 1. In addition to the configuration of the optical system 1, the optical system 2 includes a third lens unit (third unit) LU3 that forms a third optical path RY3 to guide light emitted by a light emitting surface LS to the eye EYE. In the third optical path RY3, the light emitted by the light emitting surface LS transmits through the third lens unit LU3, and then transmits through the first half-transmissive reflective surface HM1 of the first lens G11 and the second half-transmissive reflective surface HM2 of the second lens G12 to illuminate the eye EYE. Since the light transmits through the third lens unit LU3, the size of the optical system can be smaller than that when the light emitting surface is disposed outside the lens outer diameter. The light diffused by the eye EYE or the light reflected by the cornea is guided to the imaging surface IM by the first lens unit LU1 and the second lens unit LU2.

For the size reduction purposes, the display element, the image sensor, and the light emitting element may be arranged so that the normal to the display surface PNL, the normal to the imaging surface IM, and the normal to the light emitting surface LS are parallel to one another. In addition, for the size reduction purposes, the display element, the image sensor, and the light emitting element may be arranged so that the extension surface of the display surface PNL, the extension surface of the imaging surface IN, and the extension surface of the light emitting surface LS are in the same plane.

In FIG. 5, only a single light emitting surface LS is disposed, but the light emitting surface LS may be disposed at a plurality of positions to suppress light shield of reflected light by the cornea of the eye EYE caused by the eyelids, eyeball rotation, etc. In that case, the third lens unit LU3 may be disposed so as to correspond to the plurality of light emitting surfaces LS. The light emitted by the light emitting surface LS may be near-infrared light.

The third lens unit LU3 may include an optical surface having asymmetricity in order to properly illuminate the eye EYE. Thereby, an orientation angle of the light emitting surface LS can be kept constant regardless of the first lens unit LU1.

### Second Embodiment

In the optical system according to this embodiment, the basic configuration of the observation optical system is similar to that of the first embodiment, but the configuration of the imaging optical system is different from that of the first embodiment. This embodiment will discuss only the configuration different from that of the first embodiment, and will omit a description of the configuration similar to that of the first embodiment.

FIG. 6 is a sectional view of the optical system 2 according to this embodiment. The second lens unit LU2 includes an aperture stop SP, a third lens G21, and a fourth lens G22, arranged in this order from the pupil EP side to the display surface PNL side. The third lens G21 has a refractive surface. This configuration can bring the imaging surface IM closer to the display surface PNL by bending the traveling direction of the light beam in a direction approaching the display surface PNL while suppressing sensitivity due to temperature rise and manufacturing errors of the lenses. In addition, the image sensor constituting the imaging surface IM and the display element constituting the display surface PNL can be integrated, and the size of the optical system can be reduced.

In this embodiment, the third lens G21 has a refractive surface and the fourth lens G22 has a diffractive surface, but this embodiment is not limited to this example. For example, the third lens G21 may have a refractive surface on one surface and a diffractive surface on the other surface. An optical surface may also include a metasurface surface. In order to correct a variety of aberrations, the order of optical elements may be changed or the number of lenses may be increased, as necessary.

In this embodiment, the distances S1 and S2 are −17.0 and −16.4, respectively, and the value S2/S1 is 0.964.

In this embodiment, the distances L1 and L2 are −18.5 and −16.4, respectively, and the value L2/L1 is 0.886.

In this embodiment, the angle θ is 0.104π [rad].

### Observation Apparatus

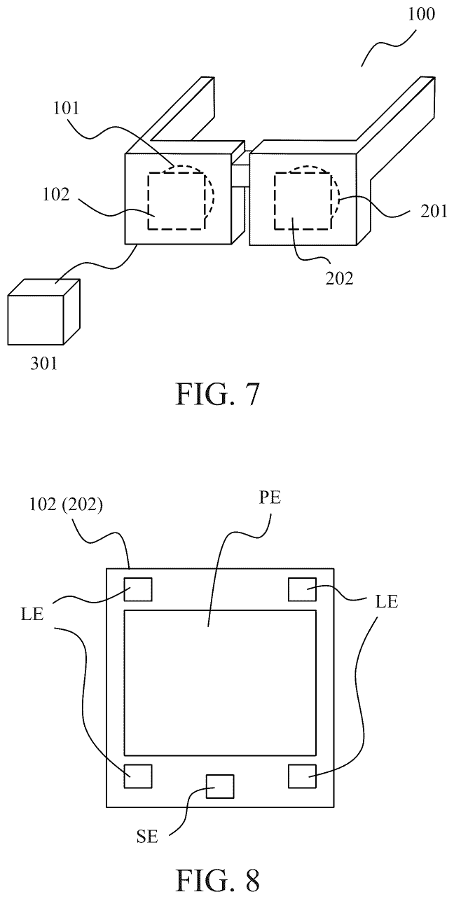

FIG. 7 illustrates an observation apparatus 100 including the optical system according to the first or second embodiment. FIG. 8 illustrates the display units 102 and 202 of the observation apparatus 100.

The observation apparatus 100 includes optical systems 101 and 201 and display units 102 and 202. Each of the display units 102 and 202 includes a display element PE, an image sensor SE, and a light emitting element LE. The display element PE, the image sensor SE, and the light emitting element LE may be formed on an integrated panel surface, or may be configured as separate members.

The observation apparatus 100 allows an image displayed by the display unit 102 to be viewed as an enlarged image on the right eye side of the observer through the optical system 101, and allows an image displayed by the display unit 202 to be viewed as an enlarged image on the left eye side of the observer through the optical system 201. The display units or optical systems may be different for the left and right sides depending on the eyesight of the observer, etc. One image sensor SE and four light emitting elements LE are placed, but the positions, numbers, and sizes can be properly modified and varied.

The pupil image and the reflected image from the cornea of the observer acquired by the image sensor SE are converted into the line-of-sight (visual line) direction by a calculator 301 built into the observation apparatus 100 or provided outside of and connected to the observation apparatus 100. Depending on the line-of-sight direction, the resolutions of the display images displayed on the display units 102 and 202 can be changed, or a user interface on the display (not illustrated) can be processed. It can also be used as an authentication unit for identifying the observer by the iris image of the observer. The pupil image, the reflected image from the cornea, and the iris image may be acquired from a single eye.

### NUMERICAL EXAMPLES

Numerical examples 1 and 2 corresponding to the first and second embodiments, respectively, will be illustrated.

In the surface data of each numerical example, r represents a radius of curvature of each optical surface, and d represents a distance on the optical axis of the first lens unit LU1 between m-th and (m+1)-th surfaces. Each unit has a unit of mm, where m is a surface number counted from the pupil EP side. nd and νd respectively represent a refractive index and an Abbe number of the optical element based on the d-line as the reference for the corresponding surface number. The Abbe number νd of a certain material is expressed as follows:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer line.

An imaging angle refers to an angle that a principal ray of a light beam guided from a position on the optical axis O of the pupil EP makes with the optical axis O in the second optical path RY2.

In a case where an optical surface is aspheric, an asterisk * is added to the right side of the surface number. The aspheric shape is expressed as follows:

$$Z = ( {y}^{2} / r ) / [ 1 + {\{ 1 - ( 1 + k ) {( y / k )}^{2} \}}^{1 / 2} ] + A 4 \cdot {y}^{4} ++ A 6 \cdot {y}^{6} + A 8 \cdot {y}^{8} + A 10 \cdot {y}^{10}$$

where y is a height from the optical axis in a direction orthogonal to the optical axis, r is a radius of curvature, Z is a displacement amount from a surface vertex in the optical axis direction, k is a conic coefficient, and A4, A6, A8, and A10 are aspheric coefficients of each order.

In a case where the optical surface is a diffractive surface, a double asterisk ** is added to the right side of the surface number. The diffractive surface gives a rotationally asymmetrical phase change centered on the surface vertex, and is expressed as follows:

$$F = {\sum }_{( i = 0 , j = 0 )} {C}_{n} {x}^{i} {y}^{j}$$

Here, Y direction (Y-axis) is a direction from the optical axis O toward the center position of the imaging surface IM in the direction orthogonal to the optical axis O (Z-axis), X-axis is a direction orthogonal to the Y-axis and Z-axis, and Cn is a diffraction coefficient. A coefficient number n is calculated as follows:

$$n = \{ {( i + j )}^{2} + i + 3 j \} / 2$$

Each of eccentricities Y1 and Y2 respectively represents a parallel eccentric amount in the Y-axis direction in the first and second embodiments, and has a unit of mm. α2 represents tilt eccentricity around the X-axis, and a tilt angle is expressed as an angle in the YZ plane with the counterclockwise direction as positive with respect to the optical axis direction (Z-axis), and has a unit of rad.

“E±XX” in each coefficient means “×10^{±XX}.”

### Numerical Example 1

The characteristics of the optical system 1 according to the first embodiment will be illustrated in Tables 1-1, 1-2, 1-3, 1-4, and 1-5 below.

TABLE 1-1
SURFACE DATA

| | | | | | | Effective | |
|---|---|---|---|---|---|---|---|
| | Surface | | | | | Diameter | |
| | No. | r | d | nd | νd | (Y, Z) | Eccentricity |
| | 1 | ∞ | 18.00 | | | 25.00 | |
| G12 | 2* | 103.00 | 5.00 | 1.5440 | 56.0 | 17.00 | |
| | 3 | ∞ | 3.00 | | | 17.00 | |
| G11 | 4* | 160.00 | 6.00 | 1.5440 | 56.0 | 21.00 | |
| | 5 | −108.42 | 5.70 | | | 21.00 | |
| Aperture | 6 | ∞ | 0.00 | | | 0.98 | Y1 |
| Stop | | | | | | | |
| G21 | 7** | ∞ | 0.75 | 1.4585 | 67.8 | 3.00 | Y1 |
| | 8 | ∞ | 0.75 | | | 3.00 | Y1 |
| G22 | 9** | ∞ | 0.75 | 1.4585 | 67.8 | 3.00 | Y1′ |
| | 10 | ∞ | 0.75 | | | 3.00 | Y1′ |
| | 11 | ∞ | 1.10 | | | 30.00 | |
| | Image | ∞ | | | | 30.00 | |
| | Plane | | | | | | |

TABLE 1-2
ASPHERIC DATA

Surface No.

| | 2 | 4 |
|---|---|---|
| r | 103 | 160 |
| K | 0 | 0 |
| A4 | 1.00E−06 | −2.00E−06 |
| A6 | 0 | 0 |
| A8 | 0 | 0 |
| A10 | 0 | 0 |

TABLE 1-3
DIFFRACTION CHARACTERISTIC DATA
Diffraction Order: 1st Order, Normalized Wavelength: 870 mm
Surface No.

| 7 | | | | 9 | | | |
|---|---|---|---|---|---|---|---|
| C1 | 0 | C15 | 0 | C1 | 0 | C15 | 0 |
| C2 | 0.8250 | C16 | −0.0183 | C2 | 0 | C16 | −4.5937E−05 |
| C3 | −0.0091 | C17 | 0 | C3 | −0.2239 | C17 | 0 |
| C4 | 0 | C18 | −0.0187 | C4 | 0 | C18 | −0.0047 |
| C5 | −0.0331 | C19 | 0 | C5 | −0.1745 | C19 | 0 |
| C6 | 0 | C20 | −0.0126 | C6 | 0 | C20 | 0.0027 |
| C7 | −0.0403 | C21 | 0.0022 | C7 | 0.0157 | C21 | 0.0003 |
| C8 | 0 | C22 | 0 | C8 | 0 | C22 | 0 |
| C9 | −0.0260 | C23 | −0.0128 | C9 | 2.1582E−10 | C23 | −1.2308E−10 |
| C10 | 0.0144 | C24 | 0 | C10 | −0.0036 | C24 | 0 |
| C11 | 0 | C25 | −0.0344 | C11 | 0 | C25 | 0 |
| C12 | 0.0691 | C26 | 0 | C12 | −1.7136E−09 | C26 | 0 |
| C13 | 0 | C27 | −0.0077 | C13 | 0 | C27 | 0 |
| C14 | 0.0376 | C28 | 0 | C14 | 0 | C28 | 0 |

TABLE 1-4
ECCENTRIC DATA

| | |
|---|---|
| Y1 | −16.30 |
| Y1′ | −15.50 |

TABLE 1-5
VARIOUS DATA

| | |
|---|---|
| Focal Length | 2.95 |
| Fno | 1.4 |
| Imaging Angle | 28.62 |
| Overall Lens Length | 21.95 |

### Numerical Example 2

The characteristics of the optical system 2 according to the second embodiment will be illustrated in Tables 2-1, 2-2, 2-3, 2-4, and 2-5 below.

TABLE 2-1
SURFACE DATA

| | | | | | | Effective | |
|---|---|---|---|---|---|---|---|
| | Surface | | | | | Diameter | |
| | No. | r | d | nd | νd | (Y, Z) | Eccentricity |
| | 1 | ∞ | 18.00 | | | 25.00 | |
| G12 | 2* | 103.00 | 5.00 | 1.5440 | 56.0 | 17.00 | |
| | 3 | ∞ | 3.00 | | | 17.00 | |
| G11 | 4* | 160.00 | 6.00 | 1.5440 | 56.0 | 21.00 | |
| | 5 | −108.42 | 5.45 | | | 21.00 | |
| Aperture | 6 | ∞ | 0.00 | | | 0.60 | Y2, α2 |
| Stop | | | | | | | |
| G21 | 7** | ∞ | 1.00 | 1.4585 | 67.8 | 3.00 | Y2, α2 |
| | 8 | ∞ | 0.50 | | | 3.00 | Y2 |
| G22 | 9** | ∞ | 0.75 | 1.4585 | 67.8 | 3.00 | Y2 |
| | 10 | ∞ | 1.00 | | | 3.00 | Y2 |
| | 11 | ∞ | 1.10 | | | 30.00 | |
| | Image | ∞ | | | | 30.00 | |
| | Plane | | | | | | |

TABLE 2-2
ASPHERIC DATA

Surface No.

| | 2 | 4 |
|---|---|---|
| r | 103 | 160 |
| K | 0 | 0 |
| A4 | 1.00E−06 | −2.00E−06 |
| A6 | 0 | 0 |
| A8 | 0 | 0 |
| A10 | 0 | 0 |

TABLE 2-3
DIFFRACTION CHARACTERISTICS DATA
Diffraction Order: 1st Order, Normalized Wavelength: 870 mm
Surface No.
9

| | |
|---|---|
| C1 | 0 |
| C2 | 0.4018 |
| C3 | −0.2129 |
| C4 | 0 |
| C5 | −0.2091 |
| C6 | 0 |
| C7 | 0.0248 |
| C8 | 0 |
| C9 | −1.1300E−02 |
| C10 | 0.0005 |
| C11 | 0 |
| C12 | 3.5300E−02 |
| C13 | 0 |
| C14 | 0.0158 |
| C15 | 0 |
| C16 | −1.3600E−02 |
| C17 | 0 |
| C18 | 8.9175E−05 |
| C19 | 0 |
| C20 | .0.0122 |
| C21 | −5.44E−05 |
| C22 | 0 |
| C23 | −2.4900E−02 |
| C24 | 0 |
| C25 | −0.0002 |
| C26 | 0 |
| C27 | 0 |
| C28 | 0 |

TABLE 2-4
ECCENTRIC DATA

| | |
|---|---|
| Y2 | −17.00 |
| α2 | 0.1π |

TABLE 2-5
VARIOUS DATA

| | |
|---|---|
| Focal Length | 2.72 |
| Fno | 1.4 |
| Imaging Angle | 29.85 |
| Overall Lens Length | 21.70 |

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an optical system that has a reduced size and a wide viewing angle.

This application claims priority to Japanese Patent Application No. 2024-097792, which was filed on Jun. 18, 2024, and which is hereby incorporated by reference herein in its entirety.

What is claimed is:

1. An optical system configured to form an enlarged image of a display surface on an exit pupil and a reduced image of the exit pupil on an imaging surface, the optical system comprising:
a first unit having, in order in a first optical path from the display surface to the exit pupil, a first half-transmissive reflective surface and a second half-transmissive reflective surface; and
a second unit having, in order in a second optical path from the exit pupil to the imaging surface, an aperture stop and an optical element,
wherein light from the display surface transmits through the first half-transmissive reflective surface, is reflected by the second half-transmissive reflective surface, is reflected by the first half-transmissive reflective surface, transmits through the second half-transmissive reflective surface, and is guided to the exit pupil,
wherein light from the exit pupil transmits through the second half-transmissive reflective surface, transmits through the first half-transmissive reflective surface, and is guided to the imaging surface via the aperture stop and the optical element, and
wherein in a direction orthogonal to an optical axis of the optical system, a distance from the optical axis to a center of the imaging surface is equal to or less than a distance from the optical axis to a center of the aperture stop.

2. The optical system according to claim 1, wherein the following inequality is satisfied:
$$0.6 \leq S 2 / S 1 \leq 1.$$
where in the direction orthogonal to the optical axis, S1 is a distance from the optical axis to the center of the aperture stop, and S2 is a distance from the optical axis to the center of the imaging surface.

3. The optical system according to claim 1, wherein in the direction orthogonal to the optical axis, a distance from the optical axis to an intersection of an extension surface of the imaging surface and an extension of a principal ray of a light beam that is emitted from a position on the optical axis of the exit pupil and emitted from the optical element is equal to or less than a distance from the optical axis to an intersection of the extension surface of the imaging surface and an extension of the principal ray of the light beam that is emitted from the position on the optical axis of the exit pupil and enters the optical element.

4. The optical system according to claim 1, wherein the following inequality is satisfied:
$$0.6 \leq L 2 / L 1 \leq 1.$$
where in a direction orthogonal to the optical axis, L1 is a distance from the optical axis to an intersection of an extension surface of the imaging surface and an extension of a principal ray of a light beam that is emitted from a position on the optical axis of the exit pupil and enters the optical element, and L2 is a distance from the optical axis to an intersection of the extension surface of the imaging surface and an extension of the principal ray of the light beam that is emitted from the position on the optical axis of the exit pupil and emitted from the optical element.

5. The optical system according to claim 1, wherein the following inequality is satisfied:
$$0 \leq θ \leq π / 3$$
wherein θ is an angle [rad] between a first line parallel to the optical axis and an extension of a principal ray of a light beam that is emitted from a position on the optical axis of the exit pupil and emitted from the optical element, and a sign of the angle is positive in a case where an intersection of the extension of the principal ray and an extension of the optical axis in a direction parallel to the optical axis is located on an imaging surface side of the optical element, and a sign of the angle is negative in a case where the intersection is located on an exit pupil side of the optical element.

6. The optical system according to claim 1, wherein a lens surface included in the first unit has a rotationally symmetric shape with respect to the optical axis.

7. The optical system according to claim 1, wherein the optical element has a surface shape that is rotationally asymmetric with respect to the optical axis of the second unit.

8. The optical system according to claim 1, wherein the optical element has a diffractive surface.

9. The optical system according to claim 1, wherein the second unit has a plurality of diffractive surfaces.

10. The optical system according to claim 9, wherein distances from the optical axis to centers of optically effective areas of the plurality of diffractive surfaces in the direction orthogonal to the optical axis are different from one another.

11. The optical system according to claim 1, wherein the optical element has a refractive surface.

12. The optical system according to claim 1, wherein the second half-transmissive reflective surface is a surface provided on a polarization-selective reflective polarizing element.

13. The optical system according to claim 1, further comprising a circularly-polarized-light converting element disposed on a display surface side of the first half-transmissive reflective surface.

14. The optical system according to claim 13, wherein the circularly-polarized-light converting element includes a linear polarizing plate and a quarter waveplate.

15. The optical system according to claim 14, wherein the linear polarizing plate is disposed only in the first optical path.

16. The optical system according to claim 1, further comprising a third unit configured to guide light from a light emitting surface of a light emitting element to the exit pupil,
wherein the optical system has a third optical path in which the light from the light emitting surface transmits through the third unit, transmits through the first half-transmissive reflective surface, transmits through the second half-transmissive reflective surface, and is guided to the exit pupil.

17. The optical system according to claim 16, wherein a normal to the display surface, a normal to the imaging surface, and a normal to the light emitting surface are parallel to one another.

18. The optical system according to claim 16, wherein an extension surface of the display surface, an extension surface of the imaging surface, and an extension surface of the light emitting surface are located in the same plane.

19. An observation apparatus comprising:
an optical system configured to form an enlarged image of a display surface on an exit pupil and a reduced image of the exit pupil on an imaging surface;
a display element that includes the display surface; and
an image sensor that includes the imaging surface,
wherein the optical system includes:
a first unit having, in order in a first optical path from the display surface to the exit pupil, a first half-transmissive reflective surface and a second half-transmissive reflective surface; and
a second unit having, in order in a second optical path from the exit pupil to the imaging surface, an aperture stop and an optical element,
wherein light from the display surface transmits through the first half-transmissive reflective surface, is reflected by the second half-transmissive reflective surface, is reflected by the first half-transmissive reflective surface, transmits through the second half-transmissive reflective surface, and is guided to the exit pupil,
wherein light from the exit pupil transmits through the second half-transmissive reflective surface, transmits through the first half-transmissive reflective surface, and is guided to the imaging surface via the aperture stop and the optical element, and
wherein in a direction orthogonal to an optical axis of the optical system, a distance from the optical axis to a center of the imaging surface is equal to or less than a distance from the optical axis to a center of the aperture stop.

20. An observation apparatus comprising:
an optical system configured to form an enlarged image of a display surface on an exit pupil and a reduced image of the exit pupil on an imaging surface;
a display element that includes the display surface;
an image sensor that includes the imaging surface; and
a light emitting element having a light emitting surface,
wherein the optical system includes:
a first unit having, in order in a first optical path from the display surface to the exit pupil, a first half-transmissive reflective surface and a second half-transmissive reflective surface;
a second unit having, in order in a second optical path from the exit pupil to the imaging surface, an aperture stop and an optical element; and
a third unit configured to guide light from a light emitting surface of a light emitting element to the exit pupil,
wherein light from the display surface transmits through the first half-transmissive reflective surface, is reflected by the second half-transmissive reflective surface, is reflected by the first half-transmissive reflective surface, transmits through the second half-transmissive reflective surface, and is guided to the exit pupil,
wherein light from the exit pupil transmits through the second half-transmissive reflective surface, transmits through the first half-transmissive reflective surface, and is guided to the imaging surface via the aperture stop and the optical element,
wherein in a direction orthogonal to an optical axis of the optical system, a distance from the optical axis to a center of the imaging surface is equal to or less than a distance from the optical axis to a center of the aperture stop, and
wherein the optical system has a third optical path in which the light from the light emitting surface transmits through the third unit, transmits through the first half-transmissive reflective surface, transmits through the second half-transmissive reflective surface, and is guided to the exit pupil.
